(19) United States
(12) Patent Application Publication
(10) Pub. No.: US 2008/0145119 A1
(43) Pub. Date: Jun. 19, 2008

(54) IMAGE FORMING APPARATUS AND PROCESS CARTRIDGE USED THEREIN

(76) Inventors: Kenzo TATSUMI, Osaka (JP); Yoshihiro Kawakami, Hyogo (JP); Yoshiyuki Shimizu, Osaka (JP); Tomohiro Kubota, Osaka (JP); Hirobumi Ooyoshi, Tokyo (JP); Tomofumi Yoshida, Tokyo (JP); Koji Kato, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/949,339

(22) Filed: Dec. 3, 2007

(30) Foreign Application Priority Data
Dec. 13, 2006 (JP) 2006-335778

(51) Int. Cl. G03G 21/00

(52) U.S. Cl. 399/359

(57) ABSTRACT

An operation to recycle a process cartridge comprising a mechanism for returning waste toner not used in image formation from an image carrier to a developing device can be performed easily, and situations in which an image creating element that has not reached the end of its life is discarded together with an image creating element that has reached the end of its life, making reuse thereof impossible, can be suppressed. The process cartridge comprises an image carrier unit including an image carrier, a developer carrier unit including developing means, and a waste toner conveyance unit having a built-in waste toner conveyance mechanism. These three units are assembled detachably.

### BACKGROUND OF THE INVENTION

1. Field of the Invention

The present invention relates to an image forming apparatus such as a copier, a printer, a facsimile apparatus, or a compound apparatus combining the functions thereof, which forms a toner image on a recording medium such as a recording sheet or an OHP sheet through an electrophotographic process, and more particularly to a process cartridge in which a photosensitive body serving as an image carrier and a development roller of a developing device are formed integrally, and which can be attached to and detached from the image forming apparatus.

2. Description of the Related Art

An image forming apparatus includes a large number of image creating elements, such as an image carrier and a developing device. The developing device performs development processing using a developer housed therein, and therefore the developer is consumed over time. At a stage where a predetermined amount of a single component developer has been consumed or a stage where the toner concentration of a two-component developer has fallen below a predetermined value, the developer or toner must be replenished. To achieve this, proposals have been made in the past for automating fresh toner (developer) replenishment and carrier replacement, but in all such cases, the developing device is provided with rotary members such as a development roller and an agitating screw, and as time passes, these components gradually deteriorate. Moreover, during image formation processing, the image carrier is irradiated with light, and therefore also deteriorates over time.

In the past, specialist servicemen were relied on to perform operations for replacing these image creating elements, but nowadays the image carrier and process means that act on the image carrier are integrated into a cartridge that can be attached to the main body of the image forming apparatus, and as a result, users can perform replacement and maintenance operations themselves, leading to an improvement in operability.

Typically, in a process cartridge including at least an image carrier and a developing device, the individual image creating elements have different lifespans, and therefore the process cartridge is replaced in accordance with the image creating element having the shortest lifespan. As proposed in Japanese Patent Publication No. 3,724,753, for example, it is known that a process cartridge having an image carrier, a developing device, a charging device and a cleaning device may be replaced in its entirety by adjusting the lifespan of a developer carrier and the lifespan of a photosensitive layer of the image carrier so that they match.

The replaced old process cartridge is collected, image creating elements that have deteriorated to the end of their life are exchanged, image creating elements, attachment components and so on that can be reused are employed as is, and thus effective use of resources is achieved.

In a conventional process cartridge, the image carrier and developer carrier are sandwiched between upper and lower frame bodies, supported by two side plates, and thereby fixed into position. The respective image creating elements are positioned relative to each other using common side plates and frame bodies, and therefore, when the process cartridge is reassembled after replacing an image creating element that has reached the end of its life while employing other image creating elements, attachment components and so on that can be reused as is, the assembly operation is troublesome, and moreover, it is not easy to reproduce relative positional relationships with a high degree of precision. Hence, the image carrier and the developer carrier, which are the main portions of the image creating elements, may be supported by separate frame bodies or in separate casings to form individual units. In so doing, a unit including an image creating element that has reached the end of its life (in many cases, a photosensitive body unit) can be detached from the other unit and replaced with a new unit. For example, Japanese Patent Publication No. 3,658,372 discloses a constitution in which a cleaning frame supporting a photosensitive body drum serving as an image carrier and a developer housing frame supporting a development roller serving as a developer carrier are coupled rotatably.

Meanwhile, to reuse toner that is not used in image formation processing, toner that has been scraped from the image carrier is collected and returned to the developing device. As disclosed in Japanese Unexamined Patent Application Publication H2-171791, for example, waste toner collecting mechanisms for this purpose are often completely integrated into the process cartridge. Similarly in the aforementioned Japanese Patent Publication No. 3,724,753, a toner conveying member projects from a cleaning casing annexed to the image carrier, and a waste toner conveyance passage is formed on the exterior of the cleaning casing. Therefore, the waste toner collecting mechanism is basically integrated with the cartridge casing, or at least the image carrier unit, and as a result, the components constituting the waste toner collecting mechanism are discarded before the end of their life.

### SUMMARY OF THE INVENTION

It is an object of the present invention to provide a process cartridge that can be recycled easily and is capable of solving a problem whereby an image creating element that has not reached the end of its life is discarded together with an image creating element that has reached the end of its life, making reuse thereof impossible.

In an aspect of the present invention, a process cartridge has a constitution for returning waste toner collected from an image carrier to a developing device. The process cartridge comprises an image carrier unit including the image carrier; a developer carrier unit including the developing device; and a waste toner conveyance unit having a built-in waste toner conveyance mechanism. The three units are assembled detachably.

In another aspect of the present invention, an image forming apparatus has a process cartridge. The process cartridge comprises an image carrier unit including an image carrier; a developer carrier unit including a developing device and a waste toner conveyance unit having a built-in waste toner conveyance mechanism and the three units are assembled detachably.

In another aspect of the present invention, there is provided for a developer carrier unit in which a development roller, a new toner accommodating space, a waste toner accommodating space, and a flexible partitioning member for partitioning the new toner accommodating space and the waste toner accommodating space are provided in a housing.

### BRIEF DESCRIPTION OF THE DRAWINGS

The above and other objects, features and advantages of the present invention will become more apparent from the following detailed description taken with the accompanying drawings, in which:

FIG. 1 is a view showing the schematic constitution of a color printer serving as an embodiment of an image forming apparatus according to the present invention;

FIG. 2 is a view showing the schematic constitution of a process cartridge (image creating unit) according to this embodiment;

FIG. 3 is an exploded perspective view showing each unit of the process cartridge according to this embodiment;

FIG. 4A is a view showing an outer side of a left surface plate;

FIG. 4B is a view showing a development unit and a photosensitive body unit on an inner side of the left surface plate;

FIG. 5A is an external view showing an outer side of a waste toner conveyance unit;

FIG. 5B is a view showing the development unit and the photosensitive body unit on an inner side of the waste toner conveyance unit;

FIG. 6 is a perspective view showing the external form of the development unit;

FIG. 7 is a perspective view showing the external form of the development unit from a different angle;

FIG. 8 is a sectional perspective view showing the interior of the development unit and the photosensitive body unit on the waste toner conveyance unit side;

FIG. 9 is a sectional view showing the schematic constitution of the waste toner conveyance unit; and

FIG. 10 is a perspective view showing the external form of the photosensitive body unit.

### DESCRIPTION OF THE PREFERRED EMBODIMENT

An embodiment of the present invention will be described in detail below with reference to the drawings.

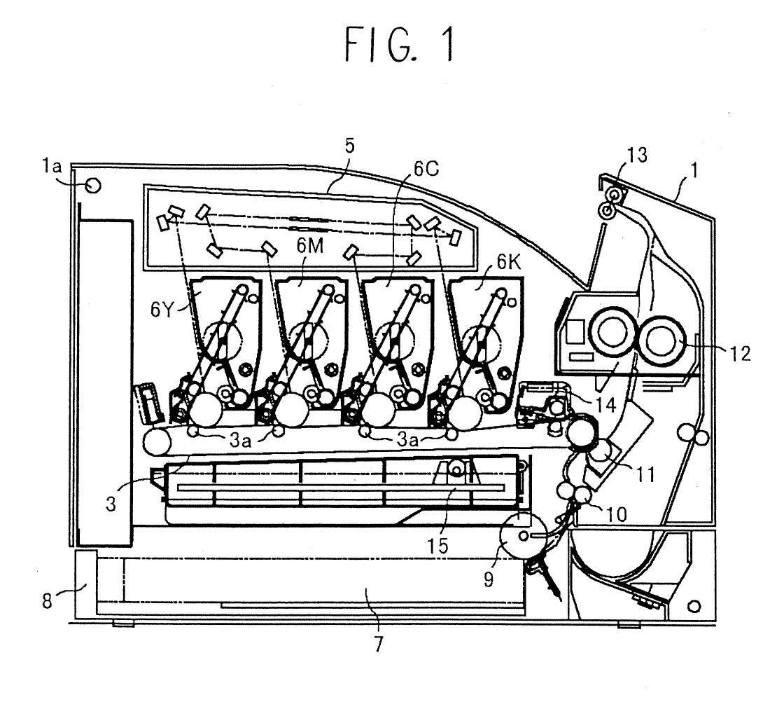

FIG. 1 shows the schematic constitution of a color printer serving as an image forming apparatus according to this embodiment. In a color printer 1, four image creating units 6 (6Y, 6M, 6C, 6K, wherein each color, namely yellow, magenta, cyan and black, is indicated by a corresponding letter) are arranged in series in a substantially central portion of a printer casing, and an exposure device 5 for forming a latent image on a photosensitive drum of each image creating unit is disposed above the image creating units 6. A transfer belt 3 wrapped around a plurality of support rollers is disposed horizontally beneath the image creating units 6. A second transfer device 11 and an intermediate transfer body cleaning device 14 are provided on the right side of the transfer belt in the drawing. A waste toner collection container 15 for collecting waste toner from the transfer belt and a sheet feeding cassette 8 for carrying/housing a recording medium 7 are disposed beneath the transfer belt 3. The recording medium 7, which is fed by a feed roller 9, passes between the transfer belt 3 and the second transfer device 11, and is then led to a fixing device 12 where a toner image is heat-fixed onto the recording medium 7.

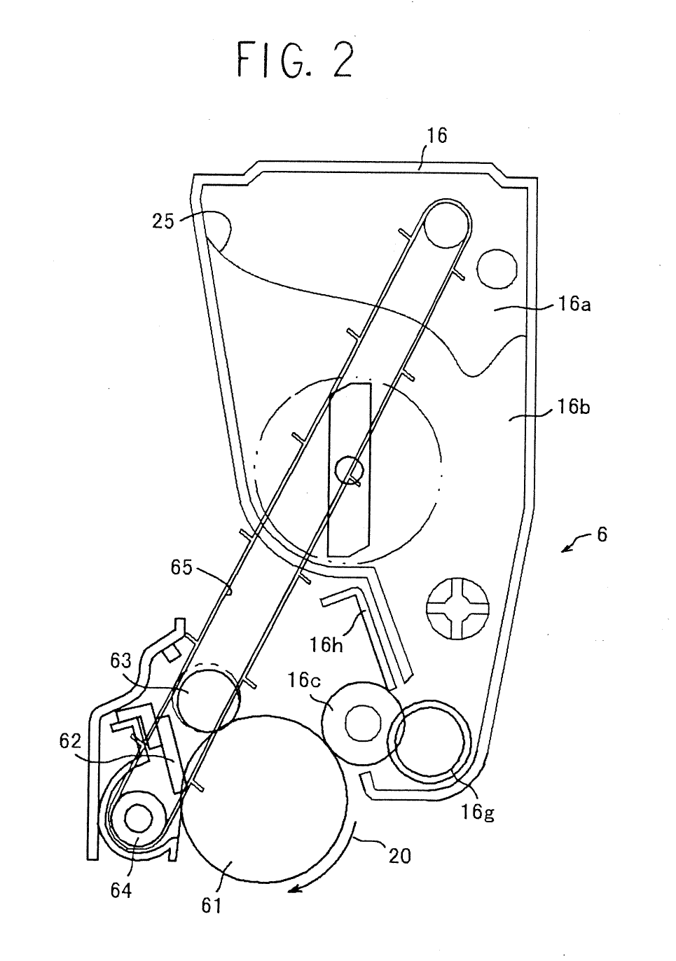

The image creating units 6K, 6C, 6M, 6Y in FIG. 1 differ only in the color of the toner image formed thereon, and the constitutions and actions for forming the toner image are identical. Therefore, in FIG. 2, only one image creating unit 6 is illustrated.

A photosensitive drum 61 serving as an image carrier is disposed in a lower portion of the image creating unit 6 so as to oppose the intermediate transfer belt 3, and is driven to rotate in a clockwise direction 20. In this embodiment, the image carrier takes a drum form, but may be a photosensitive body constituted by an endless belt. A cleaning blade 62 for scraping off toner that remains following primary transfer and a charging roller 63 contacting the photosensitive drum 61 are provided on the periphery of the photosensitive drum 61. A toner conveyance coil 64 that conveys the scraped toner horizontally is provided in the vicinity of the cleaning blade 62. Toner from the toner conveyance coil 64 is drawn up by a toner conveyance belt 65 and collected in a waste toner collection chamber 16a of a developing device 16 (to be described below). A central region of the developing device 16, which is separated from the waste toner collection chamber 16a by a partitioning member 25, serves as an unused toner chamber 16b that is filled with toner of a predetermined color in the form of a coloring powder. The developing device 16 further comprises a development roller 16c, an agitator, an agitating roller, a toner replenishment roller 16g and a development blade 16h. The development roller 16c is disposed in contact with the photosensitive drum 61 or with a minute gap therebetween.

Next, processes relating to the formation of an electrophotographic image will be described.

In FIG. 2, the photosensitive drum 61 is rotated in the rotation direction 20 by a driving device (not shown), whereby a photosensitive layer on the surface thereof is charged to a uniformly high potential, and thereby initialized, by the charging roller 63. The uniformly charged photosensitive layer is selectively exposed by the exposure device 5 on the basis of image data, and as a result of this exposure, an electrostatic latent image constituted by a low potential portion produced by potential attenuation and a high potential portion produced by initialization is formed. Next, when the low potential portion (or high potential portion) of the electrostatic latent image reaches the position of contact between the photosensitive drum and the development roller, toner is transferred from the development roller 16c having a thin layer of toner on its surface, and thus a toner image is formed (developed) on the photosensitive drum 61. Following first transfer, to be described below, toner remaining on the surface of the photosensitive drum 61 is cleaned by the cleaning blade 62 that contacts the photosensitive drum 61, whereupon the remaining charge on the drum surface is neutralized by a neutralizing device, not shown in the drawing, in preparation for the next toner image formation operation.

Returning to FIG. 1, a first transfer roller 3a used in the first transfer is disposed in a position where the image creating unit 6 contacts the transfer belt 3, and by applying a high potential to the first transfer roller 3a, a potential difference is generated between the photosensitive drum 61 and the transfer belt 3 such that the toner image formed on the surface of the photosensitive drum 61 is transferred. In the respective image creating units 6, the toner images of each color are transferred onto the transfer belt 3 in sequence, and as a result, a multicolor toner image constituted by superposed monochrome toner images is formed on the transfer belt 3.

Meanwhile, the recording medium 7 is supplied to the second transfer device 11 from the feed roller 9 and a sheet conveying device 10 at a predetermined timing. The toner image (in certain cases, a monochrome toner image) formed on the surface of the transfer belt 3 is transferred onto the recording medium 7 by applying a high potential to the second transfer device 11 such that a potential difference is generated between the transfer belt 3 and the second transfer device 11. Following transfer of the toner image, the recording medium 7 is peeled away from the transfer belt 3, whereupon the toner image is fixed onto the recording medium 7 by the fixing device 12. The recording medium 7 is then discharged onto a discharge tray on the upper surface of the printer casing via a discharge roller pair 13. Surplus toner remaining on the surface of the transfer belt 3 following transfer of the toner image onto the recording medium 7 is cleaned by the intermediate transfer body cleaning device 14 and collected in the waste toner collection container 15. The cleaned transfer belt 3 is then prepared for the next toner image transfer operation.

In this embodiment, a conveyance path of the recording medium 7 from feeding to discharge is substantially arc-shaped and has a large radius of curvature. The transfer belt 3, image creating units 6, and exposure device 5 are disposed on an inner peripheral region side of the recording medium conveyance path so that the interior space of the casing is used effectively, enabling a reduction in size. Moreover, the conveyance path is constituted simply, and the recording medium 7 is discharged with the image surface facing downward. Furthermore, the recording medium conveyance path side (the right side in FIG. 1) of the printer 1 serves as an operation front surface. With this constitution, paper jams during conveyance are prevented, enabling an improvement in reliability, and since the conveyance path is located close to the casing frame, the conveyance path can be opened easily, thereby facilitating an elimination processing operation performed when a paper jam does occur. This constitution is also suitable for a color image forming apparatus employing multiple types of recording media, in which thick paper and so on are used.

Further, since the recording medium 7 is discharged onto the color printer 1 with the image surface facing downward, recording media 7 stacked on the color printer 1 are arranged in printing order from the upper side to the lower side when the image surface side is turned upward.

Moreover, the upper portion of the color printer 1 opens about a connecting shaft 1a on the rear side of the printer casing (the left side in FIG. 1) while retaining the exposure device 5, and therefore the expendable image creating unit 6 can be replaced from the front surface. In other words, the color printer 1 is provided with a front access constitution in which all of a series of operations can be performed from the apparatus front surface, and as a result, a color printer that can be installed anywhere can be realized.

Next, a featured constitution of the present invention will be described in detail.

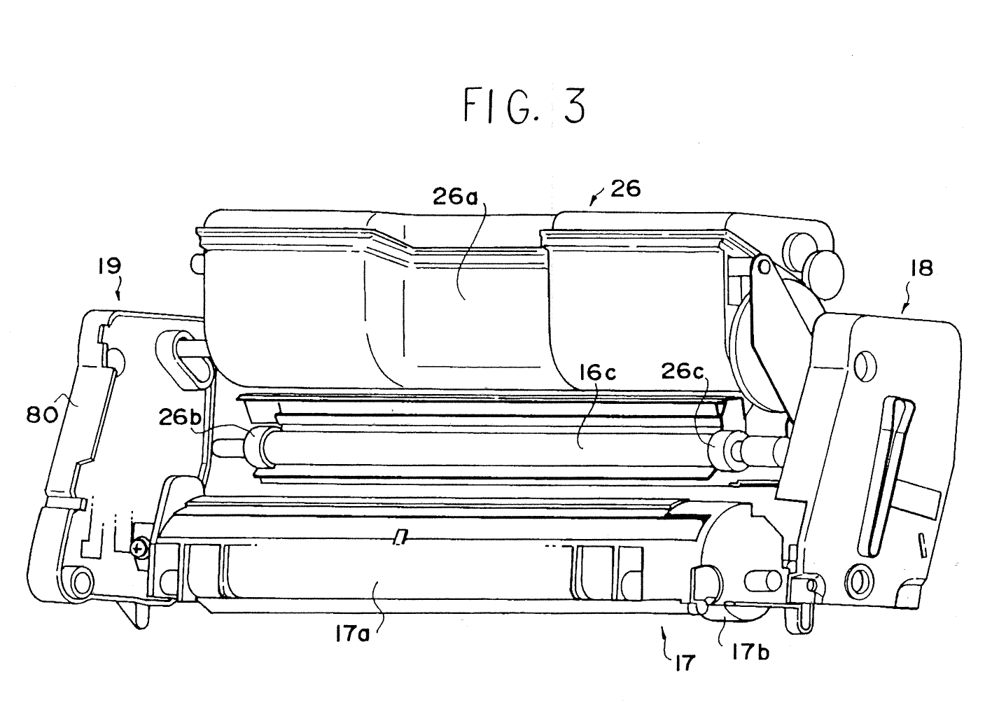

The image creating unit 6 shown in FIG. 2, including the photosensitive drum 61, the charging roller 63, the developing device 16 and the cleaning blade 62, is formed as a process cartridge that can be attached to and detached from the printer main body by a sliding action. This process cartridge is illustrated in FIG. 3. The process cartridge is constituted by four bodies, namely a developer carrier unit (referred to hereafter as a development unit) 26, an image carrier unit (referred to hereafter as a photosensitive body unit) 17, a left surface plate 18, and a waste toner conveyance unit 19 doubling as a right surface plate, the left surface plate 18 and waste toner conveyance unit 19 serving to support the two units 26, 17. The manner in which the left surface plate 18 and waste toner conveyance unit 19 sandwich and hold the development unit 26 and photosensitive body unit 17 may be identical to that of conventional left and right surface plates, and recess/projection-shaped engagement or the like is envisaged. In the waste toner conveyance unit 19, a waste toner conveyance belt is built into a unit housing 80 such that waste toner carried in from the photosensitive body unit 17 is raised upward and carried out to the development unit 26.

In the development unit 26, the development roller 16c is supported by first bearings 26b, 26c attached to left and right side faces of a development unit housing 26a. The first bearings hold the development roller 16c at predetermined distances inward from shaft tip end portions thereof. For example, when the housing length is 268 mm, the shaft length is 300 mm and the distance from the shaft tip end to the first bearing is 30 mm. Likewise in the photosensitive body unit 17, the photosensitive drum 61 is supported by first bearings 17b (for ease of illustration, only the first bearing on the left surface plate 18 side is shown in FIG. 3) attached to the left and right side faces of a photosensitive body housing 17a. The first bearings 17b of the photosensitive body unit 17 also hold the photosensitive drum 61 at predetermined distances inward from shaft tip end portions thereof. For example, when the housing length is 285 mm, the shaft length is 315 mm and the distance from the shaft tip end to the first bearing is 25 mm.

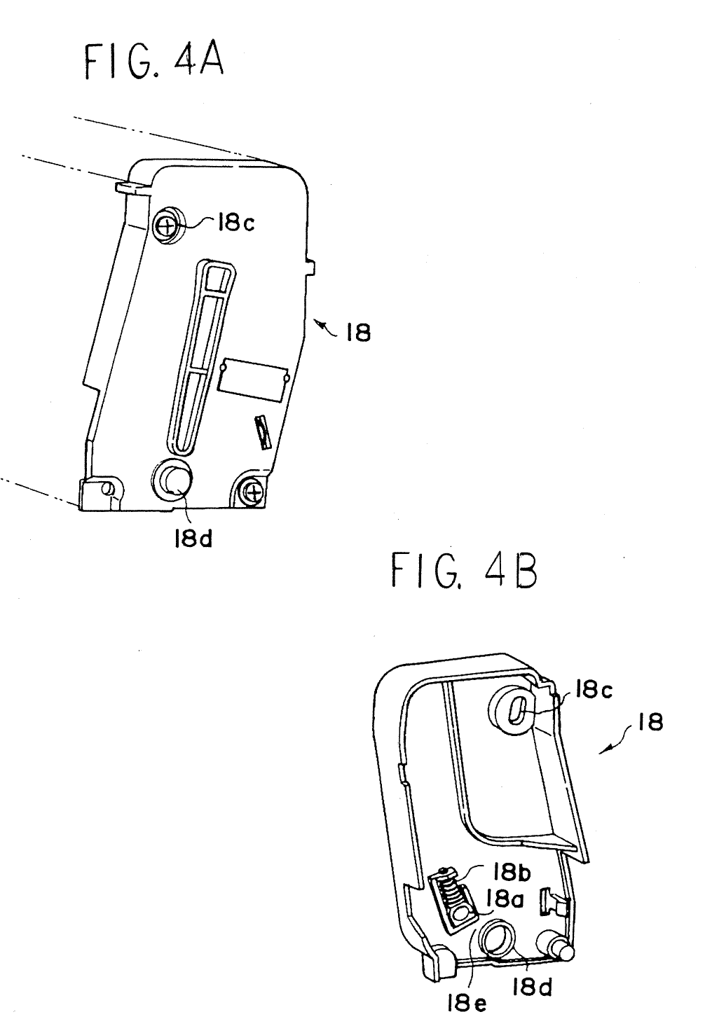

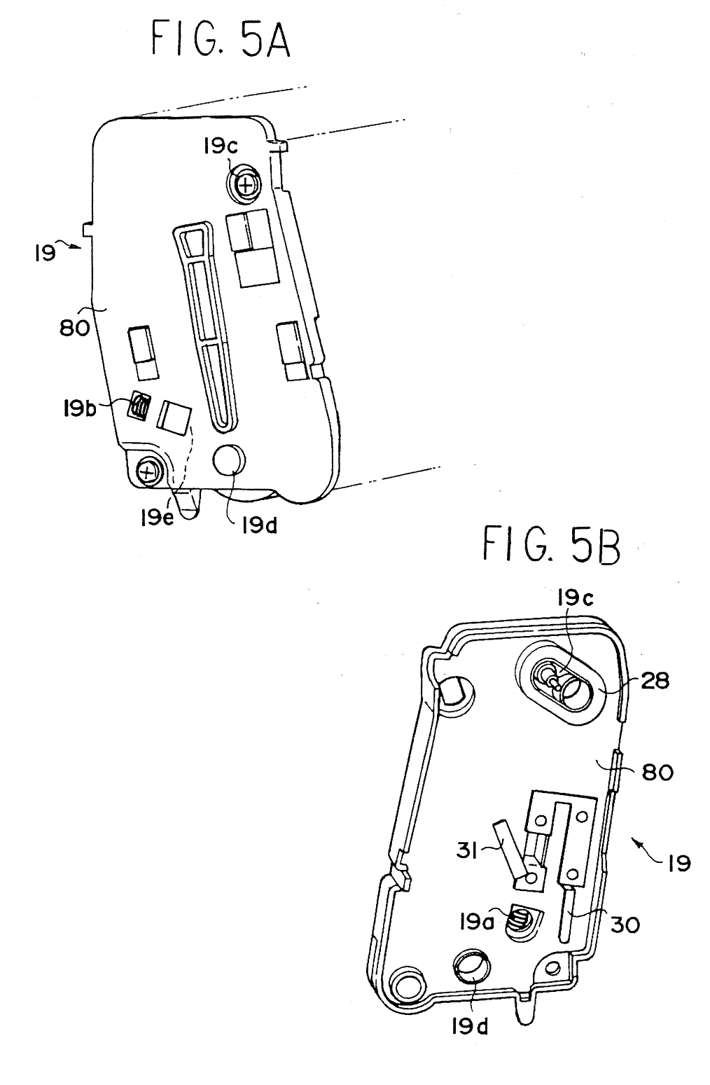

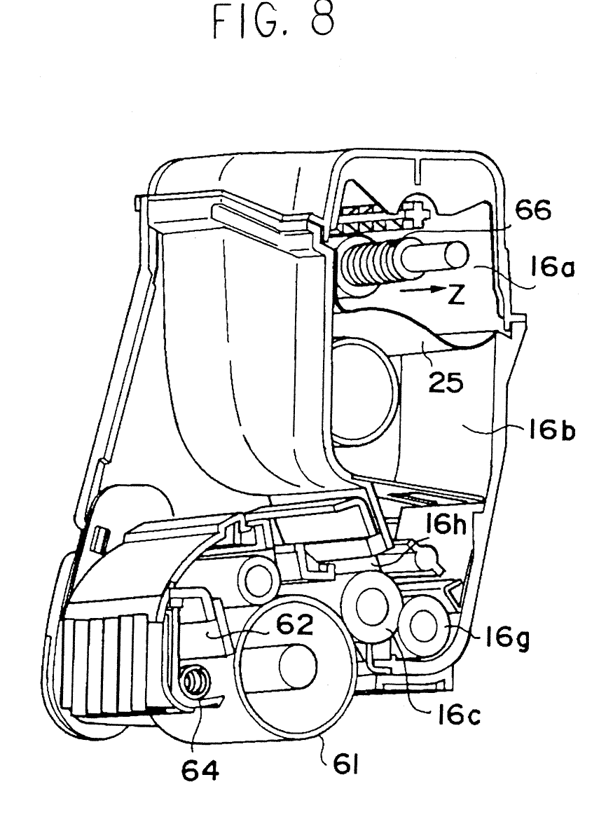

As shown in FIGS. 4A, 4B, 5A and 5B respectively, the left surface plate 18 and waste toner conveyance unit 19 for respectively supporting the development unit 26 and photosensitive body unit 17 from the two side faces thereof are provided with second bearings 18a, 19a for supporting shaft tip ends of the development roller and third bearings 18d, 19d for supporting shaft tip ends of the photosensitive body. The left surface plate 18 and waste toner conveyance unit 19 are also provided with pressure springs 18b, 19b for pressing the development roller 16c against the photosensitive drum 61 via the second bearings 18a, 19a (the pressure spring 19b is housed in the waste toner conveyance unit housing and is therefore depicted most clearly in FIG. 8, which is a sectional view of the waste toner conveyance unit). With this constitution, the second bearings 18a, 19a are capable of displacing in the direction of the photosensitive drum.

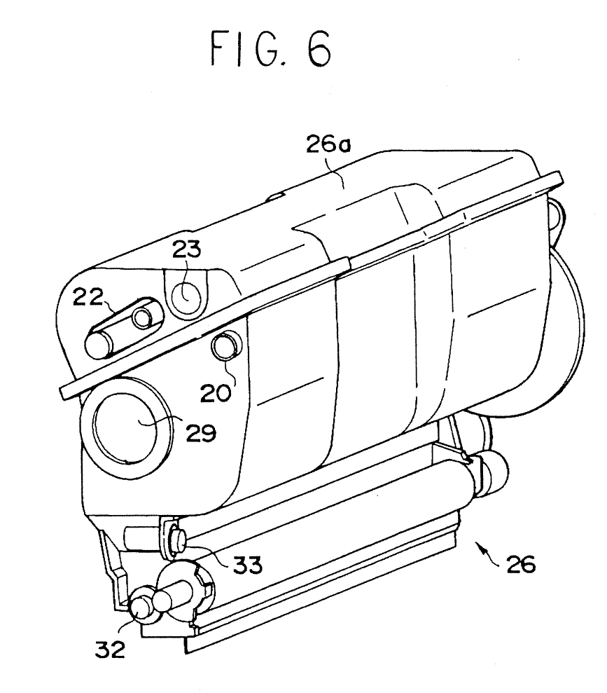

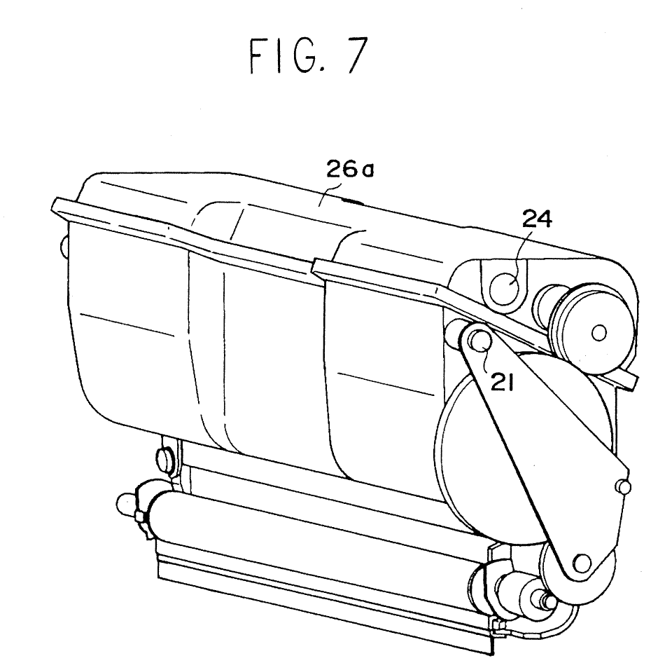

As shown in FIGS. 6 and 7, bosses 20, 21 are provided on the two upper portion side faces of the development unit housing 26a. Meanwhile, a sliding engagement portion 18c is formed as an elongated hole in the left surface plate 18, as shown in FIGS. 4A and 4B, and a sliding engagement portion 19c is formed as an elongated hole in the waste toner conveyance unit 19, as shown in FIGS. 5A and 5B. By means of these parts, the development unit housing 26a is supported so as to be capable of sliding relative to the left and right surface plates 18, 19 when the development unit 26 is sandwiched between the left surface plate 18 and the waste toner conveyance unit 19. By substantially matching the long axis direction of the elongated hole-shaped sliding engagement portions in the surface plates with the acting direction of the pressure springs, the development roller 16c can be separated from the photosensitive drum 61 easily. With this constitution, the development roller 16c can be separated from the photosensitive drum 61 during shipping by inserting wedge-shaped packing, for example, into positions 18e (FIGS. 4A and 4B) and 19e (FIGS. 5A and 5B) on the opposite side of the second bearings 18a, 19a to the pressure springs 18b, 19b. As a result, plastic deformation of the development roller, which occurs when the development roller is constantly pressed against the photosensitive drum, can be prevented in an identical manner to the proposal in the aforementioned Japanese Patent Publication No. 3,658,372.

Waste toner conveyance when the process cartridge having the four-body structure described above is assembled will now be described.

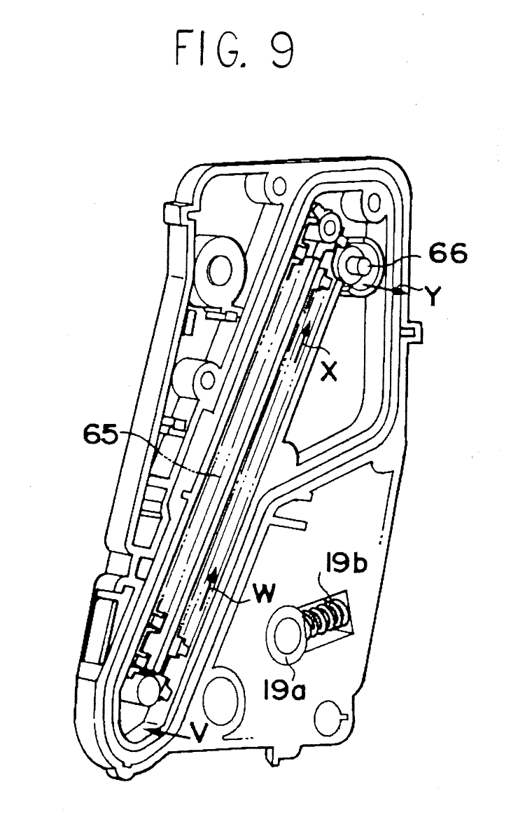

As can be seen from FIGS. 8 and 9, residual toner on the photosensitive drum 61 is scraped off by the cleaning blade 62, whereupon the scraped waste toner is conveyed by the toner conveyance coil 64 from the photosensitive unit toward the waste toner conveyance unit (in the direction of an arrow V in FIG. 9) and drawn upward in the direction of arrows W and X by the waste toner conveyance belt 65. Next, the waste toner is conveyed in the direction of arrows Y and Z (the arrow Z is shown in FIG. 8) by a waste toner conveyance screw 66 and collected in the waste toner collection chamber 16a. Note that by setting the V direction to extend from an inboard side to an outboard side, the waste toner conveyance unit can be disposed in a space where no driving-related components are located, and as a result the layout can be simplified.

When the waste toner collection chamber 16a is full of waste toner, the flexible partitioning member 25, which includes a location that curves upward, bends downward. The space beneath the partitioning member 25 serves as the unused toner chamber 16b, and as the amount of toner in the unused toner chamber decreases, the partitioning member 25 becomes able to bend downward, thereby increasing the waste toner capacity of the waste toner collection chamber 16a. In other words, the size of the cartridge is reduced by performing waste toner collection efficiently within a limited space. Note that PUR or foamed PUR is used as the material of the flexible partitioning member.

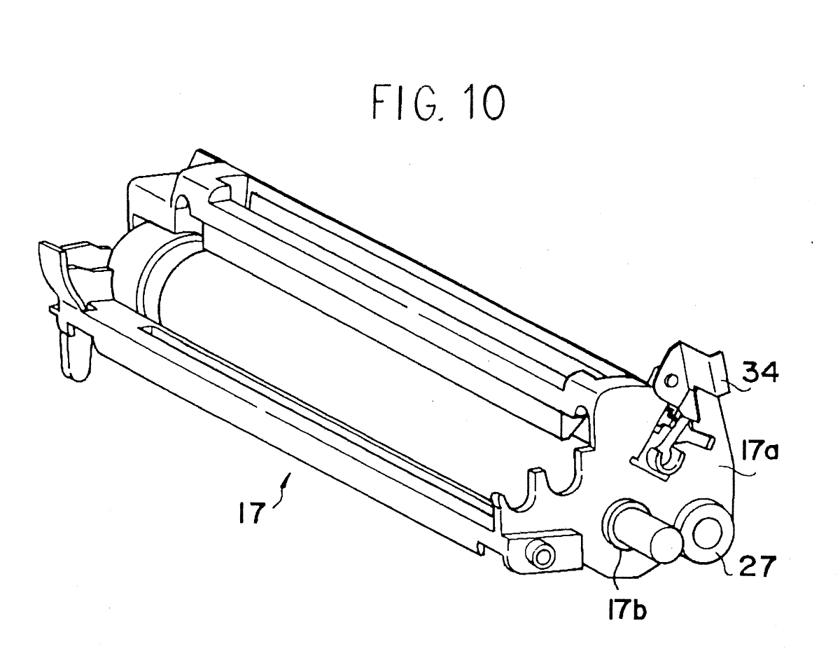

In the locations of the arrows V and Y in the series of waste toner conveyance operations described above, a sealing member 27 (FIG. 10) and a sealing member 28 (FIGS. 5A and 5B) are provided respectively on an end surface of the photosensitive body housing 17a of the photosensitive body unit 17 and an end surface of the waste toner conveyance unit 19, which doubles as a right side plate of the unit housing 80, to prevent toner from leaking through the seams between the photosensitive body unit 17 and the development unit 26.

Note that in FIG. 6, a cap 29 blocking a new toner charging port is attached to an end surface of the development unit housing 26a of the development unit 26 on which the boss 20 is provided. The cap 29 prevents toner leakage following charging. The end surface on this side is also formed with a waste toner introduction port 22 for letting the waste toner drawn upward and conveyed by the waste toner conveyance unit into the waste toner collection chamber. By providing the waste toner introduction port 22 on the same surface as the new toner charging port, waste toner leakage through the waste toner introduction port 22 during an operation to recharge new toner can be suppressed. Further, due to the four-body structure of the process cartridge, the outer side of the new toner charging port is covered by the waste toner conveyance unit 19, and therefore the user does not touch the cap 29 on the new toner charging port when attaching a new process cartridge to the image forming apparatus. Hence, there is no danger of toner leakage caused by the cap 29 being dislodged. Incidentally, waste toner suction holes 23, 24 are provided respectively on the two end surfaces of the development unit housing 26a and blocked by seals.

During electrophotographic image formation processing, a bias must be applied to the development roller 16c, toner replenishment roller 16g and development blade 16h. As shown in FIGS. 5A and 5B, the waste toner conveyance unit 19 is provided with a toner replenishment roller terminal 30 and a development blade terminal 31 for transmitting a power supply from the printer main body. These terminals 30, 31 contact a toner replenishment roller shaft end portion 32 and a development blade end portion 33 shown in FIG. 6, and apply a bias to the respective members. By providing the waste toner conveyance unit 19, which also functions as a side plate, with power supply terminals in this manner, the number of components can be reduced.

A power supply terminal 34 of the charging roller 63, shown in FIG. 10, is attached to the housing 17a of the photosensitive body unit 17 and electrically contacts a printer main body side terminal through the waste toner conveyance unit 19. Conduction with the charging portion is achieved through contact between the spring portion or a conductive bearing and the terminal, and is therefore unstable. Hence, the terminal is preferably attached to the housing of the photosensitive body unit in advance, brought securely into contact with the spring portion, and then brought directly into contact with the printer main body side terminalⁱ.

According to the present invention described above, the following features are exhibited.

(1) An image carrier unit including an image carrier, a developer carrier unit including developing means and a waste toner conveyance unit having a built-in waste toner conveyance mechanism are provided, and these three units are assembled detachably. Therefore, a recycling operation can be performed easily, and situations in which an image creating element that has not reached the end of its life is discarded together with an image creating element that has reached the end of its life, making reuse thereof impossible, can be suppressed.
(2) A housing side face of the waste toner conveyance unit functions as one of [two] side plates sandwiching the image carrier unit and the developer carrier unit, and therefore the number of components can be reduced. When the housings of the developer carrier unit and the image carrier unit support a developer carrier and the image carrier at a predetermined distance inward from respective shaft end portions thereof, the developer carrier and image carrier are held by the respective units even when the waste toner conveyance unit and the side plate are removed, and therefore the developer carrier and image carrier do not fall. Meanwhile, the respective shaft tip ends of the developer carrier and image carrier are used to achieve accurate positioning thereof on the waste toner conveyance unit and the side plate.
(3) When at least one of bearing portions respectively supporting the respective shaft end potions of the developer carrier and the image carrier is biased toward the other bearing portion by a spring, biasing contact between the developer carrier and the image carrier is achieved securely. In particular, when the bearing portion supporting the shaft end portion of the developer carrier is biased toward the bearing portion supporting the shaft end portion of the image carrier by a spring, bosses are provided on the two side faces of the housing of the developer carrier unit, and the bosses are engaged with elongated holes provided respectively in the waste toner conveyance unit side face and the side plate, biasing contact between the two members is achieved securely. Moreover, the two members can be separated prior to installation and during storage of the apparatus, and accurate positional relationships can be secured between the image carrier and the other image creating elements.
(4) When a power supply terminal is attached to the housing of the waste toner conveyance unit, the number of components can be reduced. Further, when a charging power supply terminal is attached to the housing of the image carrier unit so as to be capable of contacting a terminal on an image forming apparatus main body side through the waste toner conveyance unit, contact stability can be improved.
(5) When a development roller, a new toner accommodating space, a waste toner accommodating space, and a flexible partitioning member for partitioning the new toner accommodating space and the waste toner accommodating space are provided in the housing of the developer carrier unit, waste toner can be collected within the process cartridge, and the waste toner can be removed every time the process cartridge is replaced. When a waste toner introduction port and a new toner charging port are provided in an identical side face of the housing, a situation in which waste toner leaks during toner recharging can be avoided.

Various modifications will become possible for those skilled in the art after receiving the teachings of the present disclosure without departing from the scope thereof.

What is claimed is:

1. A process cartridge having a constitution for returning waste toner collected from an image carrier to developing means, comprising:
an image carrier unit including said image carrier;
a developer carrier unit including said developing means; and
a waste toner conveyance unit having a built-in waste toner conveyance mechanism,
wherein said three units are assembled detachably.

2. The process cartridge as claimed in claim 1, wherein a housing side face of said waste toner conveyance unit functions as one of two side plates sandwiching said image carrier unit and said developer carrier unit.

3. The process cartridge as claimed in claim 2, wherein said housing side face of said waste toner conveyance unit, which functions as said side plate, and another side plate support respective shaft end portions of a developer carrier and said image carrier.

4. The process cartridge as claimed in claim 3, wherein at least one of bearing portions respectively supporting said respective shaft end potions of said developer carrier and said image carrier is biased toward another bearing portion by a spring.

5. The process cartridge as claimed in claim 3, wherein said bearing portion supporting said shaft end portion of said developer carrier is biased toward said bearing portion supporting said shaft end portion of said image carrier by a spring,
bosses are provided on respective side faces of a housing of said developer carrier unit, and
said bosses are engaged with elongated holes provided respectively in said waste toner conveyance unit side face and said side plate.

6. The process cartridge as claimed in claim 1, wherein a housing of said developer carrier unit supports a developer carrier at a predetermined distance inward from a shaft end portion thereof.

7. The process cartridge as claimed in claim 1, wherein a housing of said image carrier unit supports said image carrier at a predetermined distance inward from a shaft end portion thereof.

8. The process cartridge as claimed in claim 1, wherein a power supply terminal is attached to a housing of said waste toner conveyance unit.

9. The process cartridge as claimed in claim 8, wherein a charging power supply terminal is attached to a housing of said image carrier unit so as to be capable of contacting a terminal on an image forming apparatus main body side through said waste toner conveyance unit.

10. An image forming apparatus having a process cartridge, wherein said process cartridge comprises:
an image carrier unit including an image carrier;
a developer carrier unit including developing means; and
a waste toner conveyance unit having a built-in waste toner conveyance mechanism, and
said three units are assembled detachably.

11. A developer carrier unit in which a development roller, a new toner accommodating space, a waste toner accommodating space, and a flexible partitioning member for partitioning said new toner accommodating space and said waste toner accommodating space are provided in a housing.

12. The developer carrier unit as claimed in claim 11, wherein a waste toner introduction port and a new toner charging port are provided in an identical side face of said housing.
